(19) United States
(12) Patent Application Publication
(10) Pub. No.: US 2022/0138873 A1
(43) Pub. Date: May 5, 2022

(54) METHOD AND SYSTEM FOR TRADING ENERGY BASED ON DYNAMIC PRICE AND DEMAND OF RENEWABLE ENERGY

(71) Applicant: Electronics and Telecommunications Research Institute, Daejeon (KR)

(72) Inventors: Yoon-Sik YOO, Daejeon (KR); Il Woo LEE, Daejeon (KR)

(73) Assignee: Electronics and Telecommunications Research Institute, Daejeon (KR)

(21) Appl. No.: 17/487,530

(22) Filed: Sep. 28, 2021

(30) Foreign Application Priority Data
Nov. 4, 2020 (KR) 10-2020-0146082
Jul. 8, 2021 (KR) 10-2021-0089763

(51) Int. Cl. G06Q 50/06; G06Q 30/02

(52) U.S. Cl. CPC G06Q 50/06; G06Q 30/0202; G06Q 30/0283

(57) ABSTRACT

An energy trading method and system based on a dynamic price and demand of renewable energy are disclosed. The energy trading method includes receiving, from an energy consumer, demand information including a demand for energy required by the energy consumer, determining a amount of generation of an energy provider that is required to satisfy the demand from the energy consumer based on the demand information, determining a generation price to be paid by the energy consumer to purchase energy based on the amount of generation, and determining an energy trading with the energy consumer based on the generation price. The energy provider provides energy to the energy consumer according to the energy trading.

### CROSS-REFERENCE TO RELATED APPLICATION(S)

This application claims the priority benefit of Korean Patent Application No. 10-2020-0146082 filed on Nov. 4, 2020, and Korean Patent Application No. 10-2021-0089763 filed on Jul. 8, 2021, in the Korean Intellectual Property Office, the disclosures of which are incorporated herein by reference for all purposes.

### BACKGROUND

### 1. Field

One or more example embodiments relate to an energy trading method and system, and more particularly, to a method and system for trading energy based on a dynamic price of renewable energy and a demand for the renewable energy.

### 2. Description of Related Art

An existing main grid may provide energy requested for a single distributed resource at a fixed energy price through an electric power retailer, which may limit the effective use of energy consumption.

The growing use of renewable energy has also increased the use of a microgrid. However, an existing microgrid may be a system that provides energy to demand-side resources and loads in response to a request for energy per day. Thus, even when extra energy is generated in an energy consumer, the energy consumer may continue to receive energy that was requested when there was a lack of energy. Also, the energy consumer may receive energy that was requested when the price of the energy was high, at the same high price even when the price of the energy is lowered. Further, the energy consumer may not make a profit by selling a surplus of energy.

Thus, there is a desire for an energy trading method that determines the price of energy dynamically based on a demand-side resource and a supplied amount and allows an energy consumer to sell excess energy.

### SUMMARY

An aspect provides a method and system for transferring optimal energy to be used by a demand-side resource and load of distributed energy resources in an environment where energy generation is unstable according to an environment, and for selling excess energy generated from the demand-side resources to a market at an optimal price.

According to an example embodiment, there is provided an energy trading method including receiving, from an energy consumer, demand information including a demand for energy required by the energy consumer, determining a amount of generation of an energy provider that is required to satisfy the demand from the energy consumer based on the demand information, determining a generation price to be paid by the energy consumer to purchase energy based on the amount of generation, and determining an energy trading with the energy consumer based on the generation price. The energy provider may provide energy to the energy consumer according to the energy trading.

The generation price may be an energy generation cost required to increase energy to be produced by the energy provider based on the amount of generation.

The energy trading method may further include transmitting the amount of generation to the energy provider. The energy provider may provide energy to the energy consumer by increasing energy produced by the energy provider based on the amount of generation.

The determining of the energy trading may include transmitting the generation price to the energy consumer and receiving, from the energy consumer, a demand amount adjusted based on the generation price and trade determining information associated with the adjusted amount of demand.

The energy trading method may further include transmitting the adjusted amount of demand to the energy provider. The energy provider may provide energy by increasing energy produced by the energy provider based on the adjusted amount of demand.

According to another example embodiment, there is provided an energy trading method including receiving, from an energy consumer, renewable energy certificate (REC) information including an amount of excess energy that is generated from the energy consumer as a amount of generation exceeds a required amount, determining a amount of generation to be reduced by an energy provider based on the REC information in response to the excess energy being received, determining an REC price to be obtained by selling the excess energy by the energy consumer based on the amount of generation, and determining an energy trading with the energy consumer based on the REC price. The energy provider may receive the excess energy from the energy consumer according to the energy trading.

The REC price may be an energy production cost that is saved when the energy provider reduces energy to be produced based on the amount of generation.

The energy trading method may further include transmitting the amount of generation to the energy provider. The energy provider may reduce energy to be produced based on the amount of generation and then receive the excess energy from the energy consumer.

According to still another example embodiment, there is provided an energy trading method including verifying whether an energy demand amount of an energy consumer exceeds an energy amount of generation of the energy consumer, transmitting demand information including a demand for energy required by the energy consumer to an energy broker when the energy demand amount of the energy consumer exceeds the energy amount of generation of the energy consumer, and receiving, by the energy consumer, energy corresponding to the demand information from an energy provider.

When the energy demand amount of the energy consumer is less than or equal to the energy amount of generation of the energy consumer, the energy trading method may further include transmitting REC information including excess energy of the energy consumer to the energy broker, and providing, by the energy consumer, energy corresponding to the REC information to the energy provider.

According to yet another example embodiment, there is provided an energy trading system including an energy provider that generates energy, and an energy broker that receives, from an energy consumer, demand information including a demand for energy required by the energy consumer, determines a amount of generation of the energy provider required to satisfy the demand from the energy consumer based on the demand information, determines a generation price required to be paid by the energy consumer to purchase energy based on the amount of generation, and determines an energy trading with the energy consumer based on the generation price. The energy provider may provide energy to the energy consumer according to the energy trading.

The generation price may be an energy production cost required to increase energy to be produced by the energy provider based on the amount of generation.

The energy broker may transmit the amount of generation to the energy provider, and the energy provider may provide energy to the energy consumer by increasing energy to be produced by the energy provider.

The energy broker may transmit the generation price to the energy consumer, and the energy consumer may adjust the demand amount based on the generation price and transmit the adjusted amount of demand and trade determining information associated with the adjusted amount of demand to the energy broker.

The energy consumer may transmit the adjusted amount of demand to the energy provider, and the energy provider may provide energy to the energy consumer by increasing energy to be produced by the energy provider based on the adjusted amount of demand.

According to further another example embodiment, there is provided an energy trading system including an energy provider that generates energy, and an energy broker that receives, from an energy consumer, REC information including an amount of excess energy that is generated from the energy consumer as a amount of generation exceeds a required amount, determines a amount of generation to be reduced by the energy provider based on the REC information in response to the excess energy being received, determines an REC price to be obtained by selling the excess energy by the energy consumer based on the amount of generation, and determines an energy trading with the energy consumer based on the REC price. The energy provider may receive the excess energy from the energy consumer according to the energy trading.

The REC price may be an energy production cost that is saved when the energy provider reduces energy to be produced based on the amount of generation.

The energy broker may transmit the amount of generation to the energy provider. The energy provider may reduce energy to be produced based on the amount of generation and then receive the excess energy from the energy consumer.

According to example embodiments described herein, it is possible to transfer optimal energy to be used by demand-side resources and loads of distributed energy resources in an environment where energy generation is unstable according to an environment, and sell excess energy generated from the demand-side resources to a market at an optimal price, thereby effectively using energy and improving utility.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating an example of an energy trading system according to an example embodiment;

FIG. 2 is a flowchart illustrating an example of an energy trading method performed by an energy consumer of an energy trading system according to an example embodiment;

FIG. 3 is a diagram illustrating an example of an energy trading method according to an example embodiment;

FIG. 4 is a diagram illustrating another example of an energy trading method according to another example embodiment; and

FIG. 5 is a diagram illustrating an example of a utility relationship of an energy consumer based on an energy trading method according to an example embodiment.

### DETAILED DESCRIPTION

Hereinafter, example embodiments will be described in detail with reference to the accompanying drawings. However, various alterations and modifications may be made to the examples. Here, the examples are not construed as limited to the disclosure and should be understood to include all changes, equivalents, and replacements within the idea and the technical scope of the disclosure.

The terminology used herein is for the purpose of describing particular examples only and is not to be limiting of the examples. As used herein, the singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains consistent with and after an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

In the description of example embodiments, detailed description of structures or functions that are thereby known after an understanding of the disclosure of the present application will be omitted when it is deemed that such description will cause ambiguous interpretation of the example embodiments.

In addition, terms such as first, second, A, B, (a), (b), and the like may be used herein to describe components. Each of these terminologies is not used to define an essence, order, or sequence of a corresponding component but used merely to distinguish the corresponding component from other component(s). Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween.

Hereinafter, example embodiments will be described in detail with reference to the accompanying drawings. Regarding the reference numerals assigned to the elements in the drawings, it should be noted that the same elements will be designated by the same reference numerals, wherever possible, even though they are shown in different drawings.

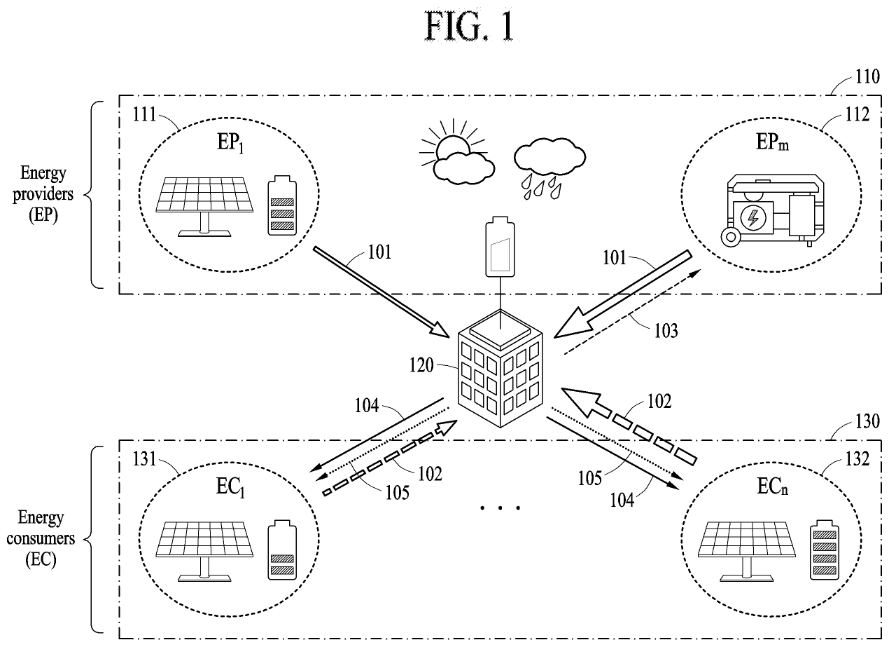

FIG. 1 is a diagram illustrating an example of an energy trading system according to an example embodiment.

An energy trading system may be an energy distribution managing system for energy trading that is performed based on a time slot-based dynamic price and demand of renewable energy in an unstable environment to optimize consumers' profits based on energy request messages. Referring to FIG. 1, the energy trading system may include an energy provider 110, an energy broker 120, and an energy consumer 130.

The energy provider 110 may produce energy 101 of an available distributed energy resource P_{m,k} and register it in the energy broker 120. Here, m may be determined by the number of energy providers and k may be determined based on the number of distributed energy resources.

In addition, the energy provider 110 may provide the energy broker 120 with a unit cost of production which is an energy production cost needed to produce energy. For example, the energy provider 110 may include an energy provider 111 (e.g., a solar photovoltaic (PV) system) that generates renewable energy and an energy provider 112 (e.g., a diesel generator) that generates energy by consuming a resource. In this example, when a amount of generation is reduced by a time or environment, the energy provider 111 may also operate as the energy consumer 130. The energy production cost may be a cost used to generate energy of a certain unit by an energy generating device, such as, for example, a diesel generator, that generates energy by consuming a resource.

The energy broker 120 may receive, from the energy provider 110, the energy 101 produced by the distributed energy resource and the unit cost of production. In addition, the energy broker 120 may receive, from the energy consumer 130, demand information including a demand for energy needed by the energy consumer 130 or renewable energy certificate (REC) information including an excess energy amount generated by the energy consumer 130 in excess of its required amount. The energy broker 120 may manage an optimal energy distribution based on the demand information or the REC information.

The energy consumer 130 may be a user that possesses a generator, such as, for example, a solar power generator, that has different amount of generations based on a time or environment. The energy consumer 130 from which excess energy is generated on a periodic basis may also operate as the energy provider 110 during a period in which the excess energy is generated.

The energy consumer 130 may include an energy consumer 131 of which a amount of generation is less than its required amount. The energy consumer 131 may transmit demand information to the energy broker 120 to request the use of a distributed energy resource. Here, the energy broker 120 may evaluate the demand information received from the energy consumer 130. The energy broker 120 may profile the demand information as history information, and analyze the history information to calculate an energy distribution amount for each energy request message based on a demand resource and load for each energy consumer requesting energy. The energy broker 120 may provide a generation price 105 to the energy consumer 130. When the energy broker 120 determines an energy trading based on the generation price 105, the energy broker 120 may provide energy produced by the energy provider 110 to the energy consumer 130 as shown by an arrow 104.

In addition, the energy consumer 130 may include an energy consumer 132 from which excess energy is generated due to a greater amount of generation than its required amount. The energy consumer 132 may resell the excess energy by transmitting REC information 102 to the energy broker 120. The energy broker 120 may purchase the excess energy based on the REC information 102, and transmit a message 103 for reducing a amount of generation based on the purchased excess energy to the energy provider 112 that needs a cost for generating energy.

The energy broker 120 may list up available distributed energy resources and optimal trading energy distribution amounts to trade the excess energy of the energy consumer 130. The energy broker 120 may provide the energy provider 110 with an incentive that is based on an energy provision contribution and provide the energy consumer 130 with a profit from the trading of the excess energy.

In addition, the energy broker 120 may maximize a sum of utilities of all energy consumers under the concept of benefits to manage energy distribution. The energy broker 120 may not allocate a greater amount of energy that exceeds an amount requested by the energy consumer 130, and thus a sum of all the allocated energy amounts may not exceed an energy amount remaining in the energy provider 110. For example, the energy broker 120 may derive an optimal profit by improving an utility from demand-side resources and loads for the energy consumer 130, as represented in Equation 1 below.

U(x,δ,s)=Σ_{i∈N,k∈K}U(x_{i,k},δ_{i,k},s_{i,k}) [Equation 1]

In Equaiton 1, U(x_{i,k}, δ_{i,k}, s_{i,k}) denotes a utility of an energy consumer_{i,k}, and U(x, δ, s) denotes a total sum of utilities. In addition, U(x_{i,k}, δ_{i,k}, s_{i,k}) may be a nonnegative real-valued function, and have a characteristic of a strictly increasing function with respect to wᵢx_{i,k} and a characteristic of a concave function with respect to x_{i,k}. In addition, a quadratic utility function may be used to measure a user's utility generally using a characteristic of a demand-side resource.

Thus, the energy broker 120 may use Equation 2 below as a utility function of the energy consumer_{i,k}.

$$U ( {x}_{i , k} , {δ}_{i , k} , {s}_{i , k} ) = \{ \begin{matrix}{w}_{i} {x}_{i , k} - \frac{{w}_{i}}{2 {δ}_{i , k}} {x}_{i , k}^{2} - {s}_{i , k} , & if 0 \leq {x}_{i , k} \leq {δ}_{i , k} \\ \frac{{w}_{i} {δ}_{i , k}}{2} - {s}_{i , k} , & if {x}_{i , k} \geq {δ}_{i , k}\end{matrix} \qquad [ Equation 2 ]$$

In Equation 2 above, K={1,2, . . . , N} may be defined as a time slot index set or a time index set of all energy consumers. x_{i,k} denotes an energy amount consumed in a kth time slot of an ith energy consumer, and wᵢ denotes a preference of the ith energy consumer. In addition, δ_{i,k} denotes a maximum charge amount of an energy storage system (ESS) in the kth time slot of the ith energy consumer, and S_{i,k} denotes an energy amount traded by the ith energy consumer with the energy broker 120 in the kth time slot of the ith energy consumer. The ESS may be a system that charges electric power generated by a generator of the energy consumer 130.

Thus, an energy distribution policy for energy trading that is based on a time slot-based dynamic price and demand of renewable energy may be represented by Equation 3 below.

$${maximize}_{H} {\sum }_{i}^{N} {\sum }_{k}^{K} ( ω U ( {x}_{i , k} , {δ}_{i , k} , {s}_{i , k} ) - {C}_{ESS} ( {e}_{i , k} ) - {C}_{REW} ( {g}_{i , k} ) - {C}_{DG} ( {G}_{i , k} ) + F ( {R}_{i , k} ) ) \\ subject to {\sum }_{i}^{N} {x}_{i , k} \leq {\sum }_{i}^{N} ( {e}_{i , k} - {g}_{i , k} + {G}_{i , k} ) , ∀ k ∈ K \\ {\sum }_{i}^{N} {g}_{i , k} = {R}_{k} , ∀ k ∈ K \qquad [ Equation 3 ]$$

where, H={x_{i,k}, δ_{i,k}, s_{i,k}, e_{i,k}, g_{i,k}, R_{i,k}, G_{i,k}|i∈N, k∈K}, ω: weight factor

In Equation 3, C_{ESS}(e_{i,k}) denotes an energy charge and discharge cost of the ESS, and C_{REW}(g_{i,k}) denotes PV operation cost. In addition, C_{DG}(G_{i,k}) denotes an energy production cost of a diesel generator, and F(R_{i,k}) denotes a trading gain of the energy provider 110 or the energy consumer 130 from trading of renewable energy.

In addition, e_{i,k} denotes an amount of energy to be charged or discharged from the energy broker 120 in the kth time slot of the ith energy consumer, and g_{i,k} denotes an amount of renewable energy traded by the energy broker 120 in the kth time slot of the ith energy consumer.

In addition, Rₖ denotes renewable energy of an R unit, and G_{i,k} denotes energy produced by the energy provider 110 in the kth time slot.

In addition, constraints may be that a demand form the energy consumer 130, a charge and discharge amount of the ESS, and a PV usage amount need to be less than an energy production amount of a supplier, and a PV production amount needs to be the same as a total amount of renewable energy.

That is, an objective function may be a strictly concave function and the constraints may be linear, and Equation 4 may be given as Lagrangian and duality conditions.

$$ℒ ( H , v , o ) = {\sum }_{i}^{N} {\sum }_{k}^{K} ( ω U ( {x}_{i , k} , {δ}_{i , k} , {s}_{i , k} ) - {C}_{ESS} ( {e}_{i , k} ) - {C}_{REW} ( {g}_{i , k} ) - {C}_{DG} ( {G}_{i , k} ) + F ( {R}_{i , k} ) ) - {\sum }_{k}^{K} {v}_{k} ( {\sum }_{i}^{N} ( {x}_{i , k} ) - {\sum }_{i}^{N} ( {e}_{i , k} - {g}_{i , k} + {G}_{i , k} ) ) + {\sum }_{k}^{K} {o}_{k} ( {\sum }_{i}^{N} {g}_{i , k} - {R}_{k} ) \qquad [ Equation 4 ]$$

In Equation 4, the objective function and an inequality constraint function may be differential and convex, and an equality constraint function may be affine, and thus an optimal solution may be obtained.

Thus, the energy broker 120 may use an optimal trading policy of x*={x*_{i,k}|i∈N,k∈K} as represented in Equation 5 below.

[symbol]

(v,o)=max_{H} [symbol] (H,v,o)

[symbol]

(v,o)=min_{v≥0,o} [symbol] (v,o) [Equation 5]

The energy trading system may transfer optimal energy by which demand-side resources and loads use a distributed energy resource in an environment where energy generation is unstable according to an environment, and sell excess energy generated by the demand-side resources to a market at an optimal cost. Thus, the energy trading system may more effectively use energy and improve a utility.

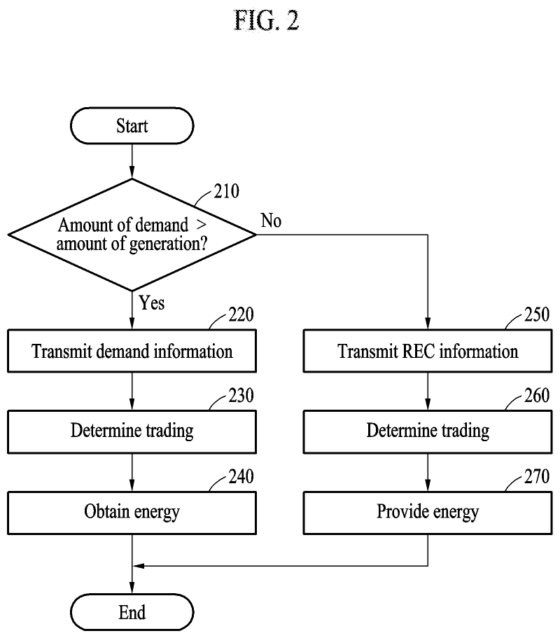

FIG. 2 is a flowchart illustrating an example of an energy trading method performed by an energy consumer of an energy trading system according to an example embodiment.

Referring to FIG. 2, in operation 210, the energy consumer 130 may verify whether an energy demand amount of the energy consumer 130 exceeds an energy amount of generation of the energy consumer 130. When the energy demand amount exceeds the energy amount of generation, the energy consumer 130 may perform operation 220. In contrast, when the energy demand amount is less than or equal to the energy amount of generation, the energy consumer 130 may perform operation 250.

In operation 220, the energy consumer 130 transmit, to the energy broker 120, demand information including a demand for energy required by the energy consumer 130.

In operation 230, the energy consumer 130 may receive a generation price corresponding to the demand information transmitted in operation 220, and may determine an energy trading based on the received generation price. The energy consumer 130 may adjust the demand amount of the energy consumer 130 based on the received generation price, and determine the energy trading based on the adjusted amount of demand. The energy consumer 130 may transmit, to the energy broker 120, the demand amount adjusted based on the generation price and trade determining information associated with the adjusted amount of demand.

In operation 240, the energy consumer 130 may receive energy corresponding to the demand information from the energy provider 110 according to the energy trading determined in operation 230.

In operation 250, the energy consumer 130 may transmit, to the energy broker 120, REC information including excess energy of the energy consumer 130.

In operation 260, the energy consumer 130 may receive an REC price corresponding to the REC information transmitted in operation 250, and determine an energy trading based on the received REC price.

In operation 270, the energy consumer 130 may provide energy corresponding to the REC information to the energy provider 110 according to the energy trading determined in operation 260.

That is, the energy consumer 130 may request energy and consume the energy in a non-peak time slot, for example, a late-night time, in which solar PV generation is not available but the power consumption of a target (e.g., factory or plant) consuming power is low. Also, the energy consumer 130 may trade energy and optimize a profit in a peak time slot in which solar PV generation is available and the household energy consumption is low, and thus excess energy is generated, but the energy consumption of the target (e.g., factory or plant) consuming power is high.

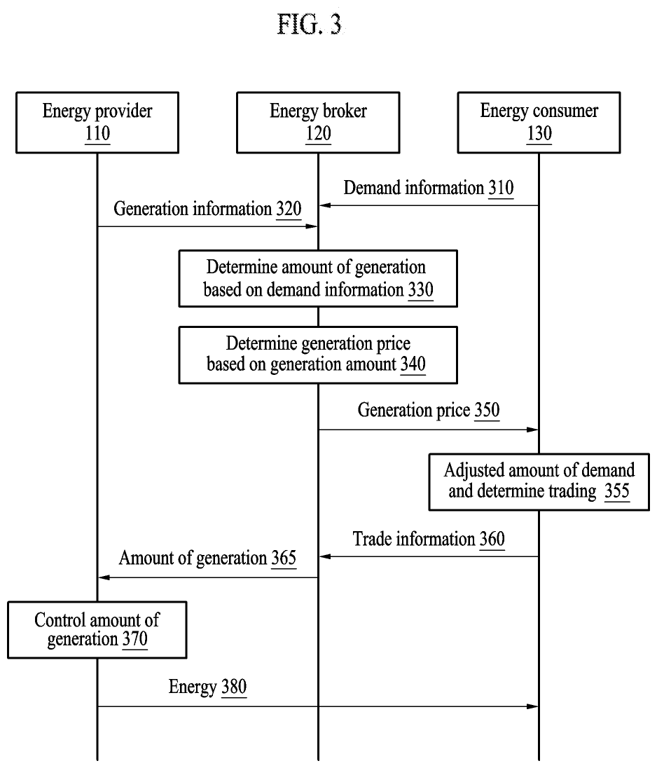

FIG. 3 is a diagram illustrating an example of an energy trading method according to an example embodiment.

Referring to FIG. 3, in operation 310, the energy broker 120 may receive, from the energy consumer 130, demand information including a demand for energy required by the energy consumer 130.

In operation 320, the energy broker 120 may receive, from the energy provider 110, generation information including an energy amount of a distributed energy resource P_{m,k} produced by the energy provider 110 and a unit cost of production which is an energy production cost required to produce energy.

In operation 330, the energy broker 120 may determine a amount of generation of the energy provider 110 required to satisfy the demand from the energy consumer 130 based on the demand information.

In operation 340, the energy broker 120 may determine a generation price that needs to be paid by the energy consumer 130 to purchase energy based on the amount of generation determined in operation 330 and the unit cost of production included in the generation information received in operation 320. The generation price may be an energy production cost required to increase energy to be produced by the energy provider 110 based on the amount of generation determined in operation 330.

In addition, the energy broker 120 may calculate a price at a time at which a supply and a demand are satisfied based on the amount of generation, and determine the calculated price as a market price which is a system marginal price (SMP). For example, the market price may be determined on an hourly basis.

In operation 350, the energy broker 120 may transmit the generation price or the market price determined in operation 340 to the energy consumer 130.

In operation 355, the energy consumer 130 may determine an energy trading based on the generation price or the market price received in operation 350. In operation 360, when the energy consumer 130 decides to purchase energy, the energy consumer 130 may transmit trade determining information to the energy broker 120.

In addition, the energy consumer 130 may adjust the demand amount of the energy consumer 130 based on the generation price or the market price received in operation 350, and determine the energy trading based on the adjusted amount of demand. In such a case, in operation 360, the energy consumer 130 may transmit the demand amount adjusted based on the generation price and the trade determining information associated with the adjusted amount of demand to the energy broker 120.

In operation 365, the energy broker 120 may transmit the amount of generation to the energy provider 110. In addition, when receiving the adjusted amount of demand in operation 360, the energy broker 120 may transmit the adjusted amount of demand to the energy provider 110. In such a case, the energy broker 120 may transmit the amount of generation or the adjusted amount of demand to the energy provider 112 that additionally produces energy using a cost among energy providers.

In operation 370, the energy provider 110 may increase energy to be produced by the energy provider 110 based on the amount of generation or the adjusted amount of demand received in operation 365.

In operation 380, the energy provider 110 may provide the energy increased in operation 370 to the energy consumer 130.

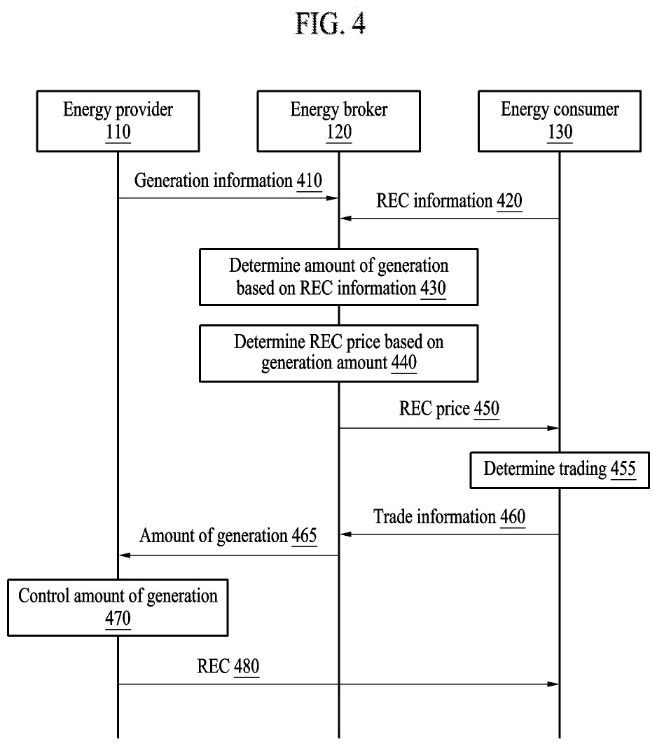

FIG. 4 is a diagram illustrating another example of an energy trading system according to another example embodiment.

Referring to FIG. 4, in operation 410, the energy broker 120 may receive, form the energy provider 110, generation information including an energy amount of a distributed energy resource P_{m,k} produced by the energy provider 110 and a unit cost of production which is an energy production cost required to produce energy.

In operation 420, the energy broker 120 may receive, from the energy consumer 130, REC information including an excess energy amount that is generated by the energy consumer 130 when a amount of generation exceeds a required amount.

In operation 430, the energy broker 120 may determine a amount of generation that is to be reduced by the energy provider 110 when excess energy amount is received, based on the REC information.

In operation 440, the energy broker 120 may determine an REC price that is to be obtained by the energy consumer 130 when the energy consumer 130 sells the excess energy based on the amount of generation determined in operation 430 and the unit cost of production included in the generation information received in operation 410. The REC price may be an energy production cost that is to be saved when the energy provider 110 reduces energy to be produced based on the amount of generation determined in operation 430.

In operation 450, the energy broker 120 may transmit the REC price determined in operation 440 to the energy consumer 130.

In operation 455, the energy consumer 130 may determine an energy trading based on the REC price received in operation 450. In operation 460, when the energy consumer 130 determines to sell the excess energy, the energy consumer 130 may transmit trade determining information to the energy broker 120.

In operation 465, the energy broker 120 may transmit the amount of generation determined in operation 430 to the energy provider 110. In such a case, the energy broker 120 may transmit the amount of generation to the energy provider 112 that uses a cost for producing energy among energy providers.

In operation 470, the energy provider 110 may reduce energy to be produced by the energy provider 110 based on the amount of generation received in operation 465.

In operation 480, the energy provider 110 may receive the excess energy from the energy consumer 130 according to the energy trading.

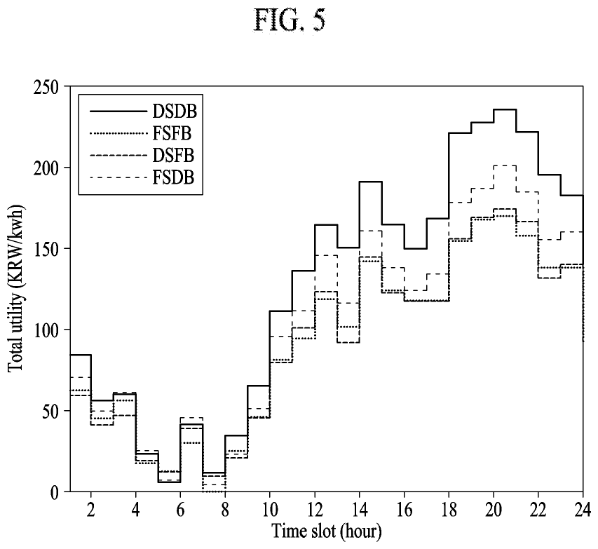

FIG. 5 is a diagram illustrating an example of a utility relationship of an energy consumer based on an energy trading method according to an example embodiment.

According to example embodiments described herein, an energy trading system may transfer optimal energy by which demand-side resources and loads may use distributed energy resources in an environment where energy generation is unstable, and sell excess energy generated from the demand-side resources to a market at an optimal price, thereby improving the effective use of energy and the unitality.

For example, as illustrated in FIG. 5, an utility of the energy consumer 130 may be improved and the energy consumer 130 that possesses demand-side resources may thus have an improved energy usage efficiency and an improved satisfaction through an energy trading based on a dynamic selling through dynamic buying (DSDB) scheme for renewable energy, compared to an energy trading based on a fixed selling through fixed buying (FSFB) scheme for renewable energy.

The energy trading system or the energy trading method described herein may be written in a program executable in a computer, and embodied as various recording media such as a magnetic storage medium, an optical reading medium, a digital storage medium, and the like.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. An energy trading method, comprising:
receiving, from an energy consumer, demand information comprising a demand for energy required by the energy consumer;
determining a amount of generation of an energy provider that is required to satisfy the demand from the energy consumer based on the demand information;
determining a generation price to be paid by the energy consumer to purchase energy based on the amount of generation; and
determining an energy trading with the energy consumer based on the generation price,
wherein the energy provider provides energy to the energy consumer according to the energy trading.

2. The energy trading method of claim 1, wherein the generation price is an energy generation cost required to increase energy to be produced by the energy provider based on the amount of generation.

3. The energy trading method of claim 1, further comprising:
transmitting the amount of generation to the energy provider,
wherein the energy provider provides energy to the energy consumer by increasing energy produced by the energy provider based on the amount of generation.

4. The energy trading method of claim 1, wherein the determining of the energy trading comprises:
transmitting the generation price to the energy consumer; and
receiving, from the energy consumer, a demand amount adjusted based on the generation price and trade determining information associated with the adjusted amount of demand.

5. The energy trading method of claim 4, further comprising:
transmitting the adjusted amount of demand to the energy provider,
wherein the energy provider provides energy by increasing energy produced by the energy provider based on the adjusted amount of demand.

6. An energy trading method, comprising:
receiving, from an energy consumer, renewable energy certificate (REC) information comprising an amount of excess energy that is generated from the energy consumer as a amount of generation exceeds a required amount;
in response to the excess energy being received, determining a amount of generation to be reduced by an energy provider based on the REC information;
determining an REC price to be obtained by selling the excess energy by the energy consumer based on the amount of generation; and
determining an energy trading with the energy consumer based on the REC price,
wherein the energy provider receives the excess energy from the energy consumer according to the energy trading.

7. The energy trading method of claim 6, wherein the REC price is an energy production cost that is saved when the energy provider reduces energy to be produced based on the amount of generation.

8. The energy trading method of claim 6, further comprising:
transmitting the amount of generation to the energy provider,
wherein the energy provider reduces energy to be produced based on the amount of generation and then receives the excess energy from the energy consumer.

9. An energy trading system, comprising:
an energy provider that generates energy; and
an energy broker that receives, from an energy consumer, demand information comprising a demand for energy required by the energy consumer, determines a amount of generation of the energy provider required to satisfy the demand from the energy consumer based on the demand information, determines a generation price required to be paid by the energy consumer to purchase energy based on the amount of generation, and determines an energy trading with the energy consumer based on the generation price,
wherein the energy provider provides energy to the energy consumer according to the energy trading.

10. The energy trading system of claim 9, wherein the generation price is an energy production cost required to increase energy to be produced by the energy provider based on the amount of generation.

11. The energy trading system of claim 9, wherein the energy broker transmits the amount of generation to the energy provider, and
the energy provider provides energy to the energy consumer by increasing energy to be produced by the energy provider.

12. The energy trading system of claim 9, wherein the energy broker transmits the generation price to the energy consumer, and
the energy consumer adjusts the demand amount based on the generation price and transmits the adjusted amount of demand and trade determining information associated with the adjusted amount of demand to the energy broker.

13. The energy trading system of claim 12, wherein the energy consumer transmits the adjusted amount of demand to the energy provider, and
the energy provider provides energy to the energy consumer by increasing energy to be produced by the energy provider based on the adjusted amount of demand.
